(19) United States
(12) Patent Application Publication
(10) Pub. No.: US 2019/0017002 A1
(43) Pub. Date: Jan. 17, 2019

(54) Apparatus and Method for Drying Hops

(71) Applicant: Ventco LLC, Pasco, WA (US)

(72) Inventor: Edward E. Caperon, Pasco, WA (US)

(73) Assignee: Ventco LLC, Pasco, WA (US)

(21) Appl. No.: 16/038,025

(22) Filed: Jul. 17, 2018

Related U.S. Application Data
(60) Provisional application No. 62/542,441, filed on Aug. 8, 2017.
(60) Provisional application No. 62/536,375, filed on Jul. 24, 2017.
(60) Provisional application No. 62/534,066, filed on Jul. 18, 2017.
(60) Provisional application No. 62/533,577, filed on Jul. 17, 2017.

(51) Int. Cl. C12C 3/02

(52) U.S. Cl. CPC C12C 3/02

(57) ABSTRACT

An apparatus is provided for drying hops having a gas distribution supply duct, a source of heated gas, and a blower. The gas distribution supply duct has an inlet, a manifold, and a plurality of serially distributed outlets extending from an upstream end to a downstream end of the supply duct, within any two adjacent outlets, each outlet defining a progressively increasing cross-sectional area going from the upstream end to the downstream end sized to realize a substantially equal volumetric output flow rate across all of the outlets. The source of heated gas is supplied to the inlet. The blower is configured to drive the heated gas from the inlet to the outlets. A method is also provided.

### RELATED PATENT DATA

This patent claims priority to U.S. Provisional Patent Application Ser. No. 62/542,441, which was filed Aug. 8, 2017, and which is hereby incorporated herein by reference; and also claims priority to U.S. Provisional Patent Application Ser. No. 62/536,375, which was filed Jul. 24, 2017, and which is hereby incorporated herein by reference; and also claims priority to U.S. Provisional Patent Application Ser. No. 62/534,066, which was filed Jul. 18, 2017, and which is hereby incorporated herein by reference; and also claims priority to U.S. Provisional Patent Application Ser. No. 62/533,577, which was filed Jul. 17, 2017, and which is hereby incorporated herein by reference.

### TECHNICAL FIELD

This disclosure pertains to techniques for drying harvested plants and flowers. More particularly, this disclosure relates to apparatus and methods for drying hops.

### BACKGROUND

Techniques are known for drying hops using hops driers including oasts and hop kilns. However, current techniques remain largely unchanged for at least several hundred years. Frequently, heated air is driven from beneath and through a bed of hops in a manner that is likely to blow holes through the layer of hops, which causes non-uniform flow through the blown holes. Non-uniform flow of heated air through a hops bed leads to uneven drying. Drying of the hops flowers then becomes inconsistent, requiring periodic raking of the hops layer to remove the holes. Therefore, there exists a need to improve the consistency and efficiency of how hops are dried.

### SUMMARY

An apparatus and method is provided to dry hops. A duct system with a source of heat and a blower cooperate to supply substantially equal volumetric output flow rates across an array of outlets in a kiln hosing atop which a bed of hops is being dried. An array of humidity and control sensors are also configured with a control system to control a hops drying operation to improve final product quality and uniformity.

According to one aspect, an apparatus is provided for drying hops having a gas distribution supply duct, a source of heated gas, and a blower. The gas distribution supply duct has an inlet, a manifold, and a plurality of serially distributed outlets extending from an upstream end to a downstream end of the supply duct, within any two adjacent outlets, each outlet defining a progressively increasing cross-sectional area going from the upstream end to the downstream end sized to realize a substantially equal volumetric output flow rate across all of the outlets. The source of heated gas is supplied to the inlet. The blower is configured to drive the heated gas, or air from the inlet to the outlets.

According to another aspect, an air distribution assembly is provided for drying hops. The air distribution assembly includes a gas distribution supply duct having an inlet, a manifold, and a plurality of serially distributed outlets extending from an upstream end to a downstream end of the supply duct. Each outlet within a pair of outlets defines a progressively increasing cross-sectional area going from the upstream end to the downstream end sized to realize substantially equal volumetric output rate across all of the outlets.

According to yet another aspect, a hops drier is provided having a source of heated air, at least one sensor, and a controller. The source of heated air has a heater and a blower and at least one heated air outlet communicating with a kiln chamber beneath a hops bed. The at least one sensor is configured to detect a parameter indicative of moisture content of the hops bed. The controller has processing circuitry, memory, a user interface, and a database, configured to receive parameters from the at least one sensor. The database comprises indicia provided in the memory correlating operative control settings for at least one of the heater and the blower.

According to even another aspect, a control system is provided for controlling operation of a hops drier. The control system includes a plurality of sensors, a heat source, and a controller. The plurality of sensors is configured in relation to a hops bed over a hops kiln chamber. The heat source comprises a heater, a blower and a delivery duct having at least one outlet to the kiln chamber. The controller has a user interface, processing circuitry and memory. A recipe is provided in the memory correlating operating control settings for the heat source.

According to yet even another aspect, a method for drying hops is provided. The method includes: generating a uniform flow of heated air through a bed of hops; detecting humidity and temperature of the heated air before entering the bed of hops; detecting humidity and temperature of the heated air after leaving the bed of hops; determining when the detected humidity of heated air before entering the bed of hops has the same value and the detected humidity of heated air after leaving the bed of hops for a preselected period of time, such as a minute; and in response to the same value of detected humidity, turning off a heat source to the heated air; and continuing to generate a uniform flow of air without heat through the bed of hops for a preselected time for cool down of the hops.

### BRIEF DESCRIPTION OF THE DRAWINGS

FIG. 1 is partial breakaway perspective view from above of a hops drying apparatus having a gas distribution supply duct provided within a hops kiln and a heat source provided externally of the hops kiln.

FIG. 2 is longitudinal vertical sectional view of the kiln of FIG. 1 taken along line 2-2 of FIG. 1.

FIG. 3. is a transverse vertical sectional view of the kiln of FIG. 1 taken along line 3-3 of FIG. 1.

FIG. 4 is an enlarged perspective view from above of the hops drying apparatus of FIG. 1.

FIG. 5 is a plan view of the hops drying apparatus of FIG. 4.

FIG. 6 is a right side view of the hops drying apparatus of FIG. 5.

FIG. 7 is component perspective view from above of one of the peripheral supply ducts and outlet.

FIG. 8 is an assembly drawing showing assembly of FIGS. 8A-8C showing a flowchart illustrating steps in implementing hops drying using the apparatus of FIGS. 1-7.

FIGS. 8A-8C showing a flowchart illustrating steps in implementing hops drying using the apparatus of FIGS. 1-7 assembled according to the drawing of FIG. 8.

### DETAILED DESCRIPTION OF THE ILLUSTRATED EMBODIMENTS

This disclosure of the invention is submitted in furtherance of the constitutional purposes of the U.S. Patent Laws “to promote the progress of science and useful arts” (Article 1, Section 8).

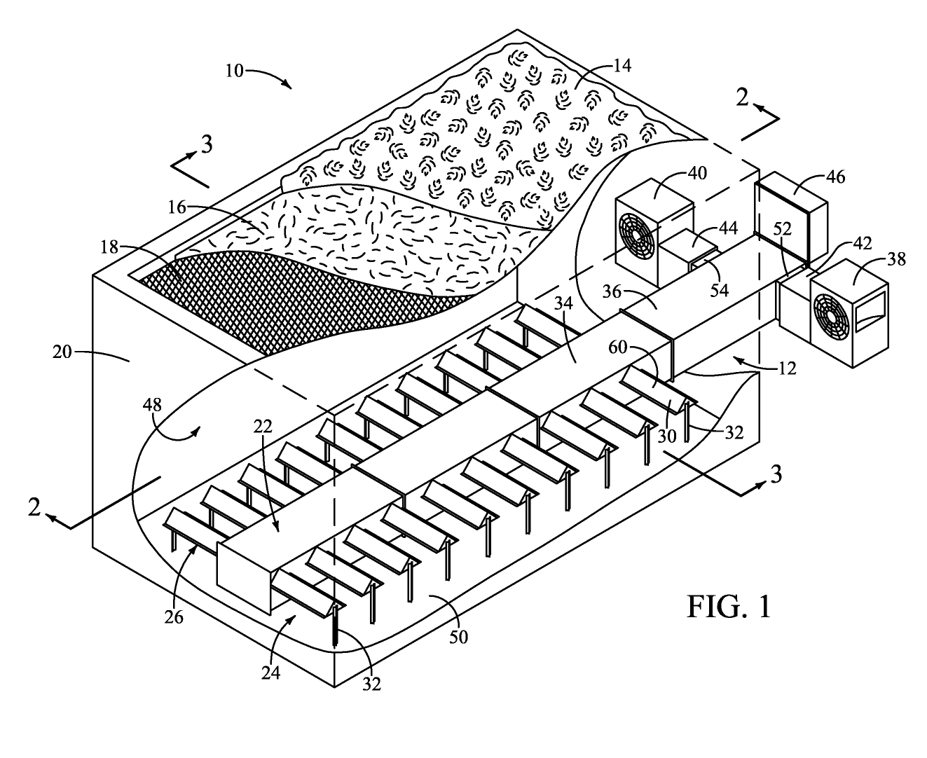

FIG. 1 illustrates one construction for a hops drying apparatus 12 implemented within a hops kiln 10. More particularly, hops drying apparatus 12 comprises a rectangular kiln housing 20 above which a uniformly perforated drying floor screen 18 such as a perforated rigid steel grate is supported. A horse hair cloth 16 is withdrawn from a roll over the drying floor screen 18 to support a layer, or bed 14 of hops for drying. A positive pressure of heated air is applied within kiln chamber 48 from a gas distribution supply duct 22. One suitable gas is air. Other gases are optionally and/or additionally envisioned. A pair of fans 38 and 40 each provides a blower configured to drive the heated gas from the inlet 52 and 54 to the outlets 30 on each of a symmetric pair of arrays 24 and 26 of parallel, laterally extending heated gas registers, such as register 60. A pair of heaters 42 and 44 provide a source of heated gas that is supplied to the inlets 52 and 54 of supply duct 22. Individual registers, such as register 60 in arrays 24 and 26 each have a three-sided, or U-shaped outlet slot, such as slot 30 sized to realize substantially identical volumetric air, or gas flow rates out of each register in arrays 24 and 26. Each register, such as register 60, has a leg, or tripod 32 supporting a distal end from first portion 34 of duct 22. Each tripod, or support leg 32 is formed from an open section of folded galvanized steel sheet metal affixed with fasteners to an outer end of each register, according to one construction. Also according to one construction, the total area of all outlets on the registers in arrays 24 and 26 substantially equals the cross-sectional area of portion 34 of secondary supply duct 22. Similarly, the cross-sectional area of each triangular register added together substantially equals the cross-sectional area of portion 34 of supply duct 22. However, these target values are varied slightly when the vertical dimension of the gap for each outlet is adjusted in order to realize substantially same output flow rates from each register.

As shown in FIG. 1, supply duct 22 of hops drying apparatus 12 includes a first portion 34 extending along a bottom floor 50 of kiln housing 20 and a second portion 36 extending upstream and outside of kiln housing 20. Heaters 42 and 44 and fans 38 and 40 respectively are coupled in sealed relation with inlets 52 and 54 to supply a source of heated external air into supply duct 22 through arrays 24 and 26 and through outlets 30 of registers, such as register 60. A control panel 46 is provided on apparatus 12 for controlling delivery of substantially uniformly distributed heated air, or gas, through bed 14 to optimize substantially uniform drying and retention of oil content for such hops.

Although a single hops drying apparatus 12 is shown in hops kiln 10, it is understood that a pair of side-by-side hops drying apparatus 12 can be provided in a larger kiln, such as a kiln with a square floor, such as a 32′ by 32′ square kiln. Other shapes are also contemplated with a plurality of hops drying apparatus 12. As shown in FIG. 1, a single hops drying apparatus 12 is shown in an 18′ by 32′ rectangular kiln having a height of at least 10′. However, it is understood that multiple drying apparatus 12 can be put side-by-side within a larger kiln chamber, such as an industry standard 32′ by 32′ chamber. In some cases, an insulated divider wall can be used to divide the chamber down the center, cutting a larger chamber in half, essentially making a unitary chamber looking like FIG. 1 with a single drying apparatus 12. Further optionally, other shapes and dimensions can be provided for supply duct 22 where outlets are sized to generate substantially same heated air flow rates out of all outlets.

According to one construction, screen 18 of FIG. 1 is a steel grate having 20% perforations by total surface area covering the hops kiln. Optionally, other percentages of perforations can be implemented. According to such one construction, a positive pressure of 1.5″ of water is generated within portion 34 of supply duct 22 using fans 38 and 40, while a positive pressure of 0.2″ of water is realized within chamber 48 during a hops drying operation. When the detected temperature (see temperature sensor 71) of air leaving above the hops bed 14 substantially equals the temperature entering the chamber (see temperature sensor 79), evaporative cooling has stopped and the hops are dried and the drying process is detected as being complete.

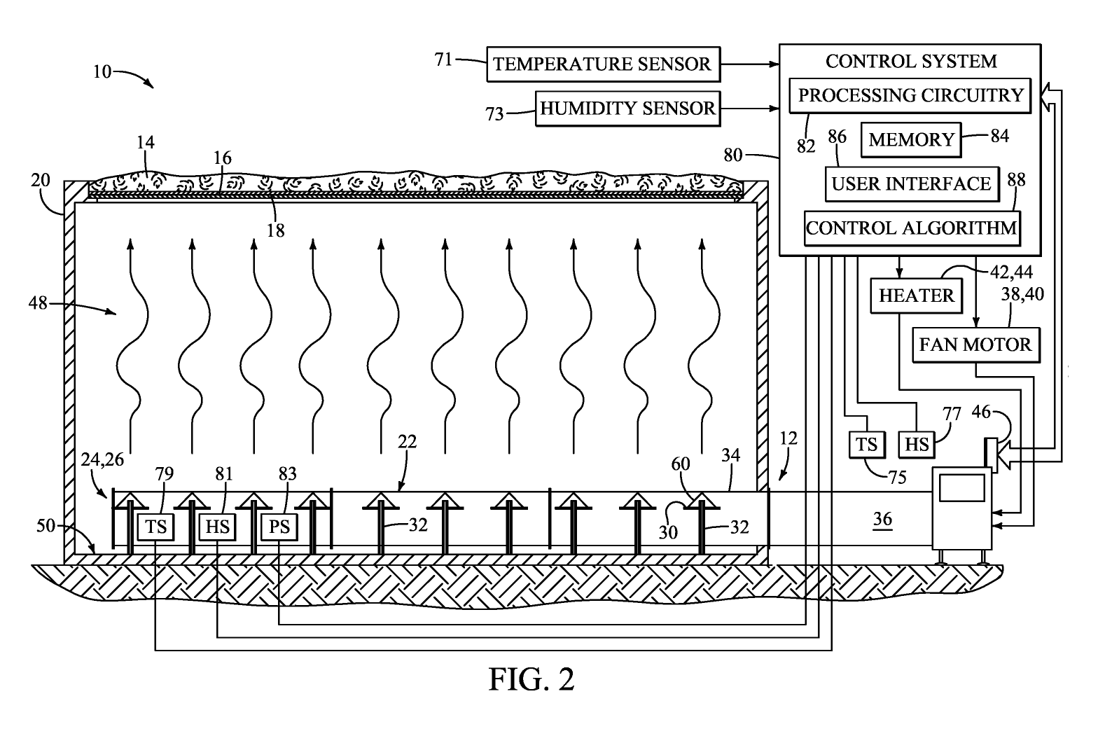

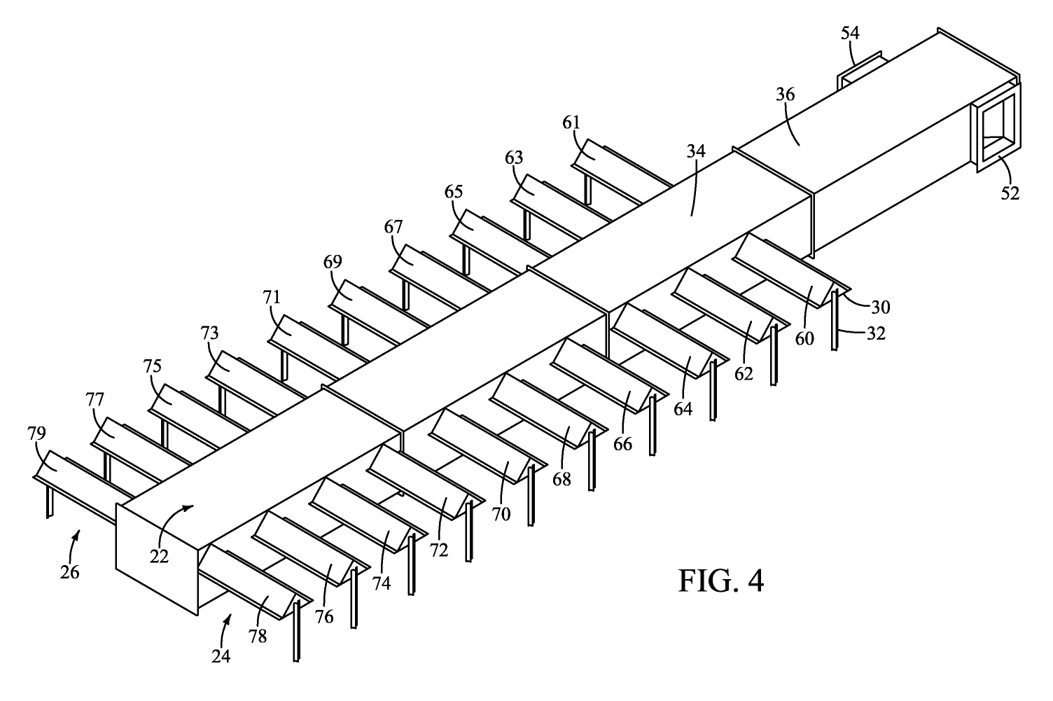

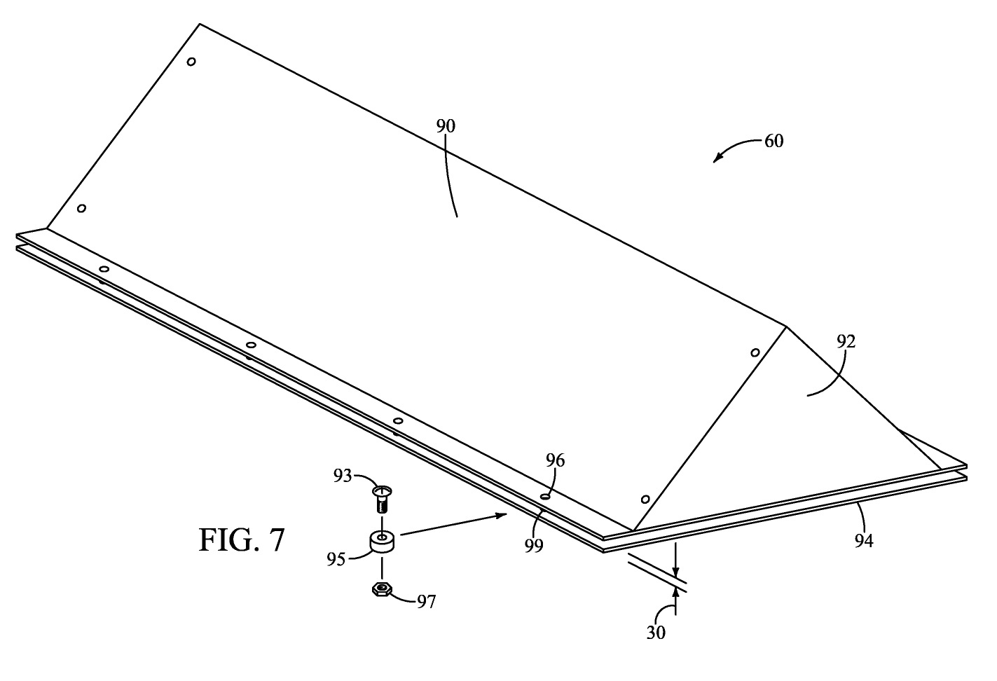

FIG. 2 illustrates placement of hops drying apparatus 12 within a chamber 48 of housing 20 of hops kiln 10. More particularly, arrays 24 and 26 are arranged in spaced-apart relation so as to deliver a substantially uniform output, or flow rate of heated air within a bottom portion of chamber 48 formed by kiln housing 20. In order to achieve such substantially uniform output, each outlet 30 on registers 60 is uniquely sized in response to flow rate measurements taken with a hot wire anemometer during setup in order to realize the substantially same volumetric flow rates from each register along arrays 24 and 26, as discussed in greater detail below with reference to FIGS. 4-7. Delivery of a substantially uniform flow rate of heated air within chamber 48 results in a substantially uniform rising flow of heated air passing from below through screen 18, cloth 16, and hops bed 14 which imparts more uniform and stable heated air flow for drying of such hops. It has been found that such more stable air flow is much less likely to blow holes through hops in the hops bed 14, thereby resulting in a much more uniform and efficient drying of such hops. Oil content in the dried hops has also been found to increase using this process. Furthermore, the time to realizing a desirably dried hops (%-age of moisture) has been decreased. Typically screen 18 is at least 10 feet above floor 50. However, other heights and kiln dimensions can be used.

Control panel 46 houses a control system 46 implemented on at least one printed circuit (PC) board (not shown) including processing circuitry 82, memory 84, a user interface 86, and a control algorithm 88. Control panel 46 is provided on portion 36 of supply duct 22, outside of kiln housing 20. Processing circuitry 82 and memory 84 are implemented on a microprocessor and memory device, such as static memory or a hard disc drive. Operation of heaters 42 and 44 and fans (via respective drive motors) 38 and 40 are controlled from a power supply by control system 46 (via control algorithm 88). Leaving air temperature and humidity is measured adjacent and on top of hops bed 14 using a temperature sensor 71 and a humidity sensor, which provide inputs to control system 46. Likewise, entering (or supply) air temperature and humidity are captured by a temperature sensor 79 and humidity sensor 81 provided at the downstream end of duct portion 34 in combination with a pressure sensor 83. Sensors 79, 81 and 83 provide signal inputs to control system 46. It is understood that sensors 79, 81 and 83 are provided in close proximity at the downstream end. For drawing purposes, they are shown spaced-apart in order to fit them into FIG. 2. Furthermore, external (or outdoor) air temperature and humidity is measured with a temperature sensor 75 and a humidity sensor 77 provided outside of hops kiln 10. Sensors 75 and 77 each provide an input signal to control system 46. Target values from such sensors can be configured in a table, or control system recipe provided in memory for operation on the control system via processing circuitry to set control system target values that trigger changes to the heater and the blower when drying a bed of hops.

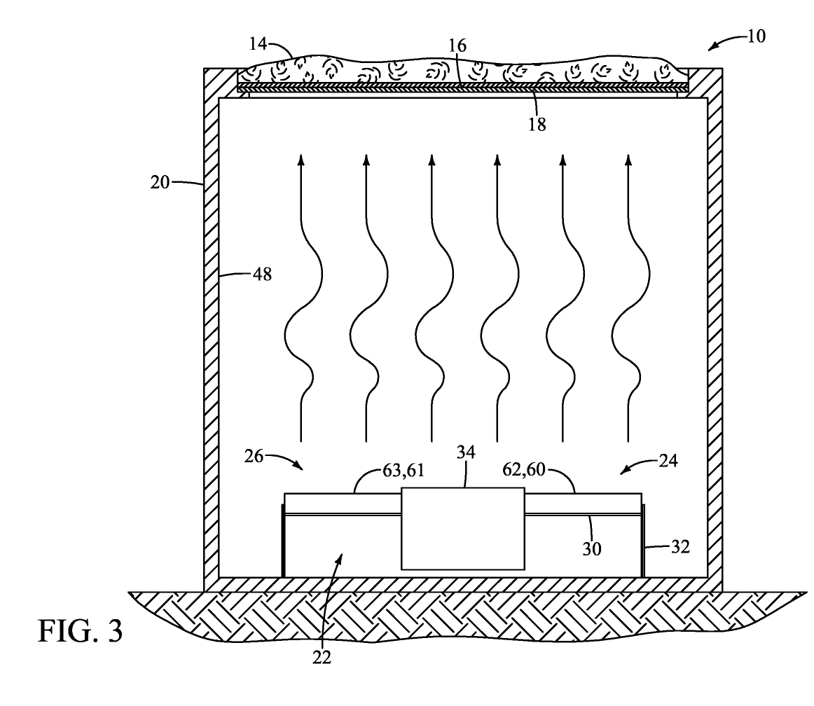

As shown in FIGS. 1-7, supply duct 22 is constructed from 16 gauge galvanized sheet metal according to one implementation. FIG. 3 illustrates the symmetric arrangement of arrays 24 and 26 of registers such as registers 60-63 provided in fluid flow with portion 34 of supply duct 22. Slit-shaped outlets 30 on each register of arrays 24 and 26 are each custom sized so as to realize substantially same air flow rates through each register into chamber 48 of housing 20. In this manner, a substantially uniform and consistent rate of heated air flows upwardly through screen 18, cloth 14, and hops bed 14 of hops kiln 10.

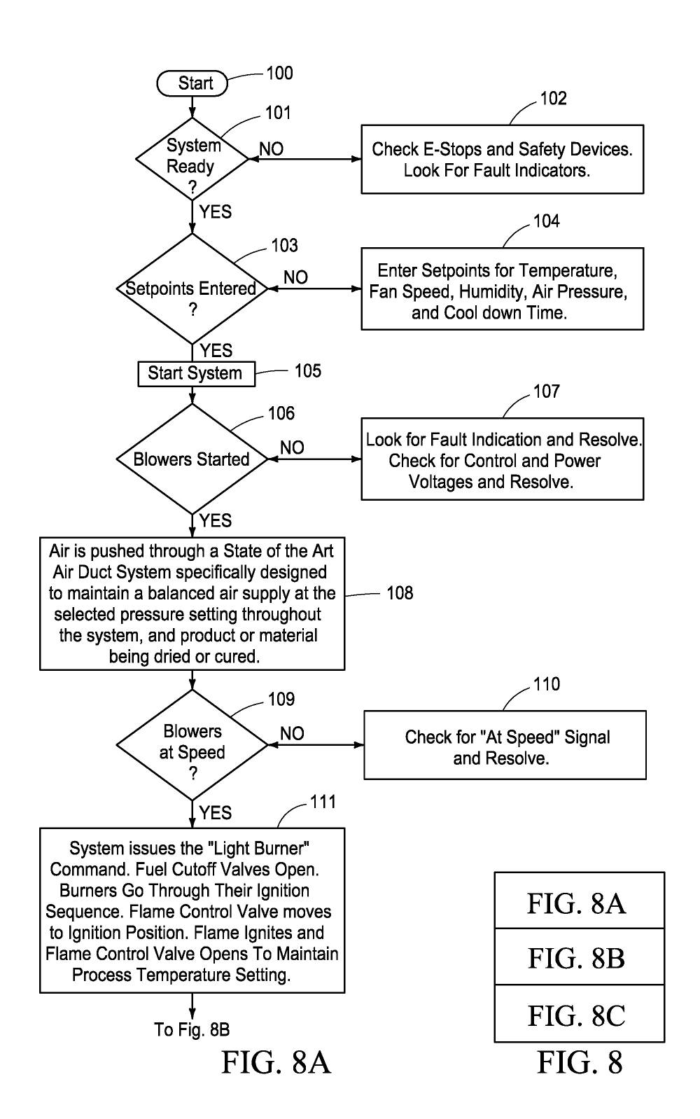

FIGS. 4-7 illustrate the symmetric and equidistance spacing between heated air registers 60-79 along portion 34 of supply duct 22. Registers 60-79 are made substantially the same size with essentially the same heated air flow path geometry except that each outlet, such as outlet 30, is sized so as to realize a substantially same flow rate out of each register 60-79. Under test conditions, a hot wire anemometer is used to measure flow rate at a plurality of locations along the three sides of outlet, or gap 30 and an average of these flow rates is used to calculate the total outlet flow rate for each register. The dimension of outlet, or gap 30 (see FIG. 7) is then sized so as to achieve a substantially identical flow rate from each outlet 30 on each register 60-79. It has been discovered through such testing that the upstream registers (closer to portion 36) have smaller outlets, or gaps 30 than the downstream registers. In one exemplary case, registers 60-63 have an outlet with a vertical gap of 18 mm, registers 64-67 have an outlet with a vertical gap of 19 mm., registers 68-71 have an outlet with a vertical gap of 22 mm., registers 72-75 have an outlet with a vertical gap of 25 mm., and registers 76-79 have an outlet with a vertical gap of 27 mm. Optionally, finer granularity can be realized by progressively increasing gap size for each outlet extending from the upstream end to the downstream end for each adjacent pair of registers that rises upwardly in a uniform manner through a bed of hops to more uniformly and efficiently dry the hops.

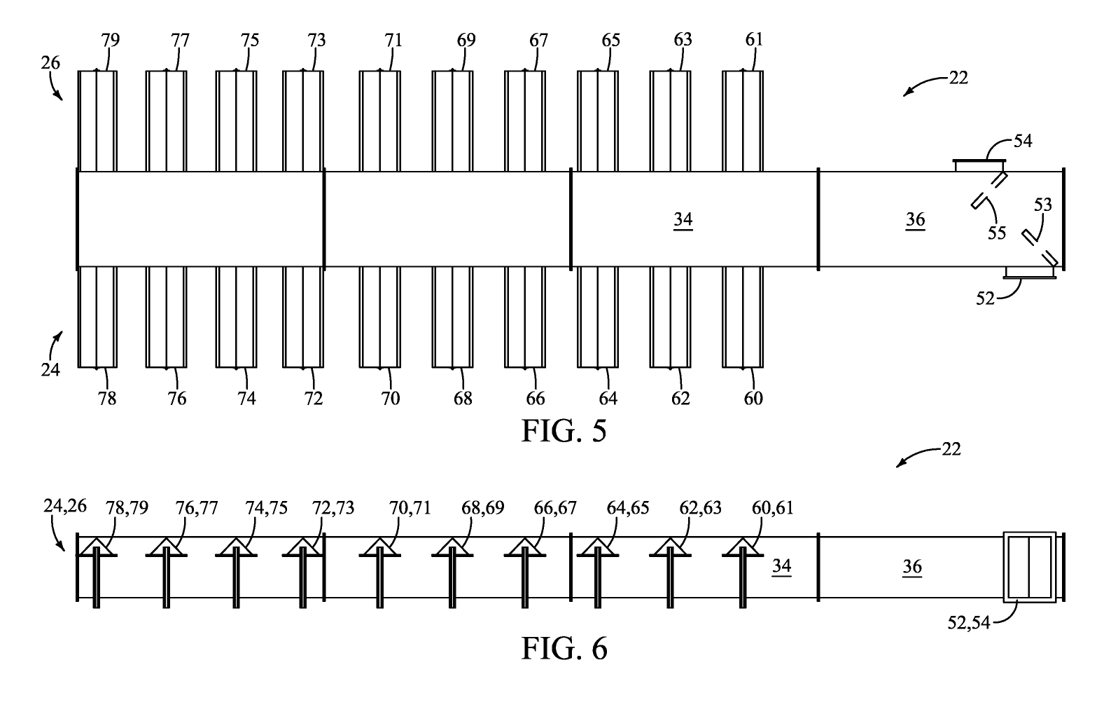

As shown in FIGS. 4-6, portion 36 includes inlets 52 and 54 on opposed vertical sides to which respective heaters and fans (not shown) are affixed to supply a source of heated air to supply duct 22. FIG. 5 depicts a pair of angled sheet metal baffles 53 and 55 that divert the sources of heated air into portion 36 to portion 34 and out through the arrays 24 and 26 of registers 60-79 for delivery within a kiln chamber in a substantially uniform flow rate across the bottom of the chamber.

FIG. 7 illustrates one exemplary register 60. Remaining registers 61-79 (not shown) are identically sized and constructed with the exception that a custom thickness cylindrical spacer 95 is sized specially for each register to realize the custom vertical gap dimension for outlet 30 that achieves substantially identical flow rates from each outlet 30 on each of the registers, as measured using a hot wire anemometer. Although not shown, it is understood that a series of threaded fasteners 93, cylindrical spacers 95, and complementarily threaded nuts 97 are affixed through respective holes 96 and 99 about the three-sided outer periphery of register 60 in sheet metal top portion 90 and bottom portion 94, respectively. Optionally, a cylindrical coil spring can be used in place of spacer 95 and a lock nut can replace nut 97. This enables accurate gap adjustment to define the gap provided by outlet 30 as calculated empirically using a hot wire anemometer. An end plate 92 is also affixed to an outer end of top portion 90 using sheet metal fasteners, or screws (not shown). Top portion 90 and end plate 92 form a concave upper surface that mates with bottom portion 94 to form a register that releases a desired heated air flow rate into a kiln chamber.

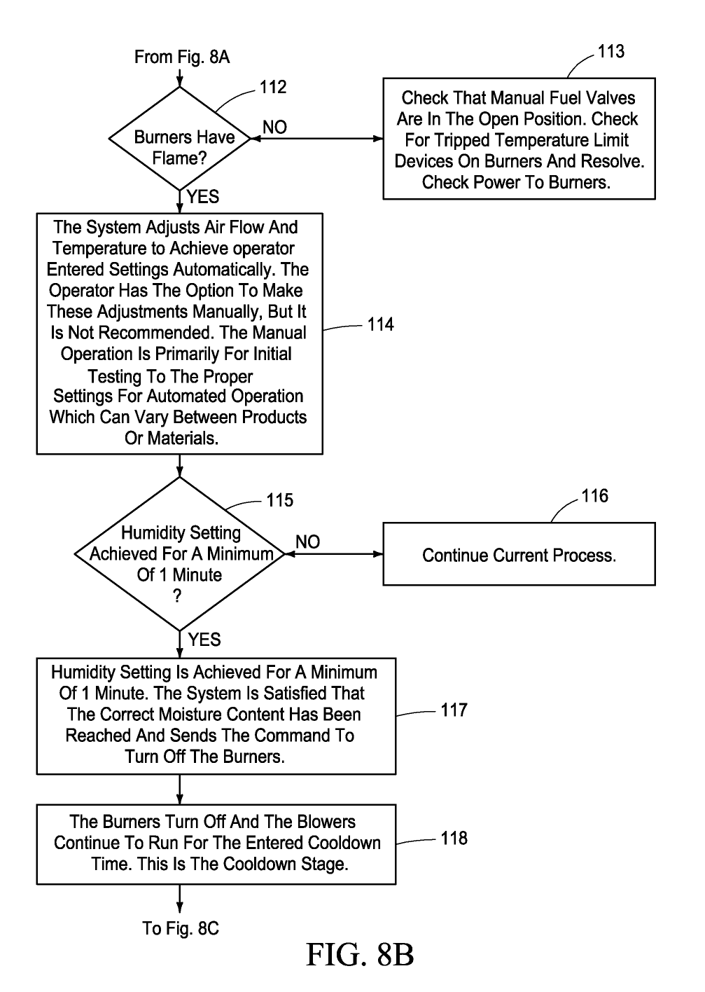

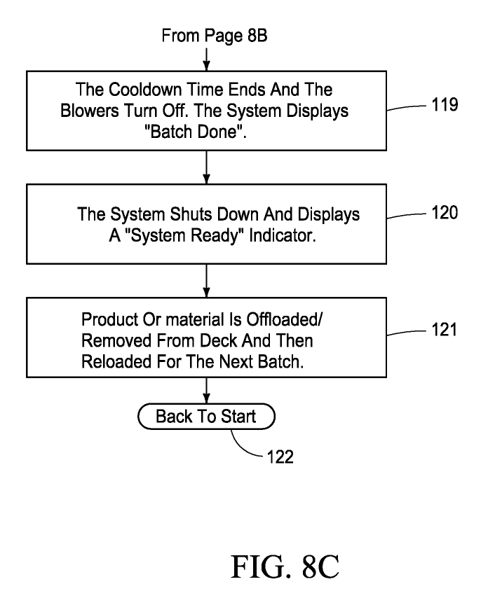

A blower VFD (variable frequency drive) control panel circuit layout with environmental control provides one way of implementing control circuitry. User Interface 86 (see FIG. 2) can be configured to realize a sequence of operations for the control system and control algorithm 88 (see FIG. 2) disclosed herein to implement the process flow steps provided in FIGS. 8A-8CD as assembled together in FIG. 8.

FIG. 8 (assembled together using FIGS. 8A-8C) is a flowchart illustrating steps in controlling the hops drying apparatus with the control system according to one exemplary embodiment. With reference to FIG. 8, a flow of logic that is executed in various embodiments when hops drying is illustrated. The process can start at step 100. After step 100, the process proceeds to step 101 where the control system of FIG. 2 determines whether the system is ready. If the system is ready, the process proceeds to step 103. If the system is not ready, the user is prompted in step 101 (via the user interface) to check for E-stops and safety devices, and to look for fault indicators. In step 103, the control system determines whether the set points have been entered into memory of the control system. If it is determined that the set points are already entered, the process proceeds to step 103. If the set points are not already entered, the process proceeds to step 104. In step 104, a user enters the set points for temperature, fan speed, humidity, air pressure, and cool down time at the user interface. In step 105, the hops drier system is started. After performing step 105, the process proceeds to step 106. In step 106, a query is made as to whether the blowers have started. If the blowers have started, the process proceeds to step 108. If the blowers have not started, the process proceeds to step 107. In step 107, the control system looks for fault indication and resolve. It checks for control and power voltages and resolve. In step 108, the hops drying apparatus and control system pushes air through a supply duct having balanced, substantially equal volumetric flow rates at a plurality of distributed locations within a hops kiln. The system maintains a balanced air supply at a selected pressure setting throughout the system, and through product or material being dried or cured. After performing step 108, the process proceeds to step 109.

In step 109, a query is made by the control system as to whether the blowers are at speed. If the blowers are at speed, the process proceeds to step 111. If not, the process proceeds to step 110. In step 110, the control system checks for an “at speed” signal and resolves. In step 111, the control system issues a “light burner” command. Fuel cutoff valves open. Burners go through their ignition sequence. Flame control valve moves to ignition position. Flame ignites and flame control valve opens to maintain process temperature setting. The process then proceeds to step 112. In step 112, a query is made by the control system as to whether the burners have flame. If the burners have flame, the process proceeds to step 114. If the burners do not have flame, the process proceeds to step 113. In step 113 the control system checks that the manual fuel valves are in the open position. It checks for tripped temperature limit devices on the burners and resolves. It checks the power to the burners. In step 114, the control system adjusts air flow and temperature to achieve operator entered settings automatically. The operator has the option to make these adjustments manually, but it is not recommended. The manual operation is primarily for initial testing to determine the proper settings for automated operation which can vary between products or materials. The process then proceeds to step 115. In step 115, a query is made by the control system as to whether a humidity setting is achieved for a minimum of 1 minute. If the humidity setting is achieved, the process proceeds to step 117. If it is not achieved, the process proceeds to step 116. In step 116, the control system continues the current process.

In step 117, the control system determines if a humidity setting is achieved for a minimum of 1 minute. The system is satisfied that the correct moisture content has been reached and sends the command to turn off the burners. After step 117, the process proceeds to step 118. In step 118, the control system dictates that the burners turn off and the blowers continue to run for the entered cool down time. This is the cool down stage. After performing step 118, the process proceeds to step 119. In step 119, the control system directs that the cool down time ends and the blowers turn off. The system displays “batch done”. After performing step 119, the process proceeds to step 120. In step 120, the control system directs that the system shuts down and displays a “system ready” indicator on the user interface. After performing step 120, the process proceeds to step 121. In step 121, the product or material (which has been dried) is offloaded and removed from the hops deck and then the hops deck is reloaded for a next batch of hops to be dried. After performing step 121, the process proceeds to step 122. In step 122, the process is directed by the control system to proceed back to step 100.

The user interface 86 of the control system 80 of FIG. 2 can display screen shots of the control system, target sensor values, and detected sensors values. One exemplary screen shot realizes a Kiln 1A graphical user interface for a selected hops drying apparatus used in a kiln having a configuration of six distributed hops drying apparatus, as shown in FIGS. 1-7. A second screen shot provides a graphical user interface screen shot for a screen that enables settings control, input and monitoring for an array of six different hops drying apparatus in a large multiple configuration kiln having kiln assemblies K1A through K3B. K1A and K1B are paired together in a common kiln chamber. Likewise, K2A and K2B are paired together in another common kiln chamber. Finally, K3A and K3B are paired together in yet another common kiln chamber.

Optionally or additionally, a humidifier can be added to portion 36 of supply duct 22 (of FIG. 1). Operation of the humidifier can be regulated with the control system in order to introduce moisture back into hops in a hop bed during the cool down phase. In some cases, hops in the bottom of the bed are found to have less humidity than those on the top. A relatively short introduction of humidity can help achieve a more consistent target level of humidity throughout the bed of hops. Other variations and times for introducing humidity into the bed of hops are envisioned responsive to feedback from the sensors, such as humidity and temperature (see FIG. 2).

A method is provided for drying hops. The method includes: generating a uniform flow of heated air through a bed of hops; detecting humidity and temperature of the heated air before entering the bed of hops; detecting humidity and temperature of the heated air after leaving the bed of hops; determining when the detected humidity of heated air before entering the bed of hops has the same value and the detected humidity of heated air after leaving the bed of hops for a preselected period of time, such as a minute; and in response to the same value of detected humidity, turning off a heat source to the heated air; and continuing to generate a uniform flow of air without heat through the bed of hops for a preselected time for cool down of the hops.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

In compliance with the statute, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

I/we claim:

1. An apparatus for drying hops, comprising:
a gas distribution supply duct having an inlet, a manifold, and a plurality of serially distributed outlets extending from an upstream end to a downstream end of the supply duct, within any two adjacent outlets, each outlet defining a progressively increasing cross-sectional area going from the upstream end to the downstream end sized to realize a substantially equal volumetric output flow rate across all of the outlets;
a source of heated gas supplied to the inlet; and
a blower configured to drive the heated gas from the inlet to the outlets.

2. The apparatus of claim 1, further comprising a plurality of laterally extending distributed outlet ducts each having a substantially same cross-sectional area and located longitudinally from a common location between the upstream end and the downstream end of the supply duct.

3. The apparatus of claim 1, wherein each outlet comprises a register extending laterally of the supply duct having a triangular cross-sectional configuration with a pair of right angle sides across a top side and a hypotenuse across a bottom side, and a dimensioned gap provided between a bottom edge of the sides and the hypotenuse configured to provide the respective outlet.

4. The apparatus of claim 1, wherein each outlet comprises an elongate first housing shell and an elongate second housing shell configured in assembly to provide a concavity there between and a gap provided between the first housing shell and the second housing shell sized to provide the equal volume output rate.

5. The apparatus of claim 4, wherein a parallel outlet is provided opposed from each outlet comprising an elongate first housing shell and an elongate second housing shell configured in assembly to provide a concavity there between and a gap provided between the first housing shell and the second housing shell sized to provide the equal volume output rate.

6. The apparatus of claim 5, wherein each concavity has a triangular cross-sectional configuration.

7. The apparatus of claim 1, wherein the supply duct has a cross-sectional area substantially identical to a summation of the cross-sectional areas for all of the outlets.

8. The apparatus of claim 1, wherein the duct includes an array of spaced-apart peripheral supply ducts and each aperture comprises a slit provided along each supply duct.

9. The apparatus of claim 8, wherein each supply duct comprises a pair of complementary shell portions, and wherein the slit is provided by a gauged slot provided between the pair of shell portions.

10. An air distribution assembly for drying hops, comprising:
a gas distribution supply duct having an inlet, a manifold, and a plurality of serially distributed outlets extending from an upstream end to a downstream end of the supply duct, each outlet within a pair of outlets defining a progressively increasing cross-sectional area going from the upstream end to the downstream end sized to realize substantially equal volumetric output rate across all of the outlets.

11. The air distribution assembly of claim 10, wherein each outlet comprises a gap provided in an elongate register.

12. The air distribution assembly of claim 11, wherein the register has a triangular cross-sectional configuration.

13. The air distribution assembly of claim 11, wherein pairs of bilaterally symmetric elongate registers extend from the manifold in opposed directions, each pair spaced serially along a central elongate axis of the manifold.

14. The air distribution assembly of claim 13, wherein each register in a pair has a same outlet cross-sectional area.

15. The air distribution assembly of claim 11, wherein each outlet comprises an elongate slit provided along each register.

16. The air distribution assembly of claim 15, wherein each register is a peripheral supply duct comprising a pair of complementary shell portions, and wherein the slit is provided by a gauged slot provided between the pair of shell portions.

17. A hops drier, comprising:
a source of heated air having a heater and a blower and at least one heated air outlet communicating with a kiln chamber beneath a hops bed;
at least one sensor configured to detect a parameter indicative of moisture content of the hops bed; and
a controller having processing circuitry, memory, a user interface, and a database, configured to receive parameters from the at least one sensor, the database comprising indicia provided in the memory correlating operative control settings for at least one of the heater and the blower.

18. The hops drier of claim 17, wherein the at least one sensor is a humidity sensor and the parameter is detected humidity.

19. The hops drier of claim 18, wherein the database comprises indicia correlating a burner control setting correlated to shut off the burner when humidity is detected as not changing over a preselected time period.

20. A control system for controlling operation of a hops drier, comprising:
a plurality of sensors configured in relation to a hops bed over a hops kiln chamber;
a heat source comprising a heater, a blower and a delivery duct having at least one outlet to the kiln chamber; and
a controller having a user interface, processing circuitry and memory, a recipe provided in the memory correlating operating control settings for the heat source.
